(19) United States
(12) Patent Application Publication
(10) Pub. No.: US 2010/0033331 A1
(43) Pub. Date: Feb. 11, 2010

(54) Monitoring System

(75) Inventor: Basil C. Bautovich, Cook (AU)

Correspondence Address: BRACEWELL & GIULIANI LLP, P.O. BOX 61389, HOUSTON, TX, 77208-1389, US

(73) Assignee: Conseng Pty Ltd, Cook (AU)

(21) Appl. No.: 12/518,828

(22) PCT Filed: Dec. 11, 2007
(86) PCT No.: PCT/AU07/01911

§ 371 Date: Jun. 11, 2009

(30) Foreign Application Priority Data
Dec. 11, 2006 (AU) 2006252036
Sep. 5, 2007 (AU) 2007904821

(51) Int. Cl. G08B 23/00; G01J 5/00

(52) U.S. Cl. 340/573.1; 250/338.1

(57) ABSTRACT

Disclosed is a self-contained portable freestanding monitoring unit (1) for an individual in the form of a human patient (not shown) in an aged-care facility (2). Unit (1) includes a transmitter (3) for generating a diffuse infrared field (4) that is bounded generally by broken lines. Field (4) defines at least part of a boundary (B-B) between a first region (5) in which the patient is preferentially disposed and a second region (6) adjacent to region (5). At least one receiver, in the form of a single infrared receiver (7), generates a movement signal in response to the patient entering field (4). Also provided is an alarm, in the form of an alarm circuit (8), which generates an alert signal in the form of an audible sequence of sounds in response to the movement signal.

### FIELD OF THE INVENTION

The present invention relates to a monitoring system and a monitoring unit for use in a monitoring system.

The invention has been developed primarily for use as a monitoring system for an individual such as a home care resident, aged care facility resident or hospital patient when disposed on a chair, and will be described hereinafter with reference to this application. However, it will be appreciated that the invention is not limited to this particular field of use and is also suitable for monitoring other individuals such as children, domestic animals and the like whether disposed on a chair, bed or other furniture, or in a room, or other space.

### BACKGROUND OF THE INVENTION

Any discussion of the prior art throughout the specification should in no way be considered as an admission that such prior art is widely known or forms part of the common general knowledge in the field.

In many cases, individuals such as patients in a hospital or a nursing home require constant physical care and attention from carers. Due to costs and resource limitations there are typically many more patients requiring care than there are carers—such as nurses or other health service professionals—in any given organisation. Therefore, it is not always possible to administer the highest possible level of personal physical care and support to each and every patient that may warrant attention.

Known methodologies that attempt to ameliorate this problem include the use of personal monitoring systems, video surveillance systems, pressure sensitive mats on a bed surface, physical barriers to patient movement, or the like. These types of methodologies are specifically designed for a given installation or application and suffer from one or more common disadvantages such as:
Presenting a physical barrier to movement of the patient and potentially entrapping a patient and otherwise impinging upon their legal freedoms.
Providing a high incidence of false alarms.
Being a safety hazard.
Mechanically or electrically unreliable.
Having a short operational lifetime.
Posing hygiene problems for patients.
Typically trigger once the patient completed or almost completed movement from a bed or chair to the floor.

Some of the prior art monitoring systems are fully integrated into the furniture or room being used by the patient being monitored and are therefore dedicated to that furniture or room. This considerably hinders movement of the carer or carers about the furniture or room unless the monitoring system is disabled. And where it is necessary to regularly disable a monitoring system there is a heightened risk that it will not be subsequently enabled. Moreover, such systems are often expensive to commission, operate and replace.

### SUMMARY OF THE INVENTION

It is an object of the present invention to overcome or at least ameliorate at least one of the disadvantages of the prior art, or to provide a useful alternative.

According to a first aspect of the invention there is provided a monitoring system for an individual, the system including:

a transmitter for generating a diffuse infrared field that defines at least part of a boundary between a first region in which the individual is preferentially disposed and a second region adjacent to the first;

at least one receiver for generating a movement signal in response to the individual entering the field; and

an alarm that is responsive to the movement signal for generating an alert signal.

Preferably, the transmitter and receiver are contained within a housing for maintaining the field in a predetermined orientation. More preferably, the housing also contains the alarm.

Preferably also, the housing is freestanding. More preferably, the housing is movable to maintain the field in an alternative orientation to the predetermined orientation.

In a preferred form, the field extends from a first end adjacent to the housing to a second end distal from the housing. Preferably, the system includes a controller for adjusting the distance between the first end and the second end. In some embodiments a continuous adjustment between a minimum and maximum distance is used, while in other embodiments a step-wise or indexed adjustment is used.

Preferably, the housing includes a battery for providing power to at least the transmitter and receiver. More preferably, the battery selectively provides power to at least the transmitter and receiver. Even more preferably, the battery selectively provides power to at least the transmitter and receiver when mains supply power is not available.

Preferably also, the alert signal is provided wirelessly.

According to a second aspect of the invention there is provided a monitoring system for an individual, the system including:

a transmitter for generating a diffuse infrared field that defines a zone;

at least one receiver for generating a movement signal in response to the individual entering the field;

memory for storing data indicative of a message tailored to the individual; and

a communications device that is responsive to the movement signal for retrieving the data from the memory and reproducing the message at or adjacent to the field.

In an embodiment the message is reproduced audibly. Preferably, the message is reproduced visually.

In an embodiment the individual has a native language, and the message is tailored for reproduction in the native language. Preferably, the individual has at least one relative, and the message is tailored for reproducing at least one characteristic of the relative.

In an embodiment the communications device includes a sound reproduction device. Preferably, the communications device includes a visual display.

In an embodiment the system includes one or more controls selected from:

a volume control for the communications device, wherein the message includes an audio component that is reproduced by the communications device at a predetermined volume, and the volume control allows adjustment of the predetermined volume;

a record control that is responsive to the message for storing corresponding data in the memory;

a play control for allowing reproduction of the message; and

a field adjustment control for varying one or more properties of the field.

According to a third aspect of the invention there is provided a monitoring unit for a monitoring system for an individual, the monitoring system having memory for storing data indicative of a message tailored to the individual and a communications device that is responsive to a movement signal for retrieving the data from the memory and reproducing the message, the monitoring unit including:

a transmitter for generating an infrared field; and

at least one receiver for generating the movement signal in response to the individual entering the field.

In an embodiment the transmitter and the at least one receiver are co-located. Preferably, the transmitter and the at least one receiver are co-located within a common housing.

According to a fourth aspect of the invention there is provided a monitoring unit for an individual, the unit including:

a body;

a transmitter mounted to the body for generating a field that extends away from the body;

at least one receiver associated with the transmitter for generating a movement signal in response to the individual entering the field; and

a communications device mounted to the body and having an input device for receiving audible signals and an output device for generating audible signals, and a communications module for interfacing with a communications system and the input and output devices, the communications module being responsive to the movement signal for interfacing with the communications system to allow reproduction of a live message.

In an embodiment the communications unit includes a storage device for storing a list of contact numbers. Preferably, the communications unit sequentially dials each telephone number in the list of numbers until there is a response. More preferably the monitoring unit is remotely controllable.

According to a fifth aspect of the invention there is provided a monitoring unit for a monitoring system for an individual, the monitoring unit including:

a body for mounting to a fixed support element;

a transmitter movably mounted to the body for generating two fields into which the individual is able to move, the fields remaining substantially parallel during relative movement of the transmitter and the body; and

at least one receiver for generating a movement signal in response to the individual entering one of the fields.

In an embodiment the transmitter is an infrared transmitter and the field is an infrared field. Preferably, the transmitter generates a plurality of fields having respective orientations. More preferably, the orientations are relatively adjustable.

In an embodiment, the fields are substantially parallel and the relative adjustment is of the spacing between the fields.

In an embodiment, the transmitter includes one or more field generators.

According to a sixth aspect of the invention there is provided a freestanding monitoring unit for portable use, the unit including:

a floor stand;

a body mounted to the floor stand;

a transmitter mounted to the body for generating at least one diffuse infrared field; and

at least one receiver for generating a movement signal in response to the individual crossing the field.

In an embodiment, at least one of the diffuse infrared fields is generated at approximately knee height. Preferably, at least one of the diffuse infrared fields is generated at approximately head height.

In an embodiment, at least one of the diffuse infrared fields is substantially parallel to the horizontal plane. Preferably, at least one of the diffuse infrared fields are inclined with respect to the horizontal plane.

In an embodiment the unit interfaces with a monitoring system of a predetermined facility.

According to a seventh aspect of the invention there is provided a clamp including:

a fixed arm defining a first face;

a movable footplate defining a second face that is opposed with the first face;

an adjustment device connecting the arms and being rotatable for progressing the faces toward or away from each other to selectively clampingly engage an object with the faces; and

at least one guide member for constraining relative rotation between the faces.

In an embodiment the engagement between the faces and the support element defines respective contact patches of approximately equal area. Preferably, the engagement between one of the faces and the support element defines a plurality of discrete contact patches. More preferably, the engagement between the other of the faces and the support element defines a plurality of discrete contact patches.

In an embodiment, the engagement faces are defined by respective relatively high density and relatively thin pads. Preferably, the pads have a relatively high coefficient of friction. In an embodiment the pads are preferably moulded.

In an embodiment the clamp includes a mounting formation on at least one of the arms for selectively engaging with a monitoring unit. Preferably, the engagement of the monitoring unit and the one of the arms is adjustable. More preferable, it is adjustable for one or more of: rotation; release; and translation.

According to an eighth aspect of the invention there is provided a method for monitoring an individual, the method including:

generating a diffuse infrared field that defines at least part of a boundary between a first region in which the individual is preferentially disposed and a second region adjacent to the first;

generating a movement signal in response to the individual entering the field; and

being responsive to the movement signal for generating an alert signal.

According to a ninth aspect of the invention there is provided a method of monitoring an individual, the method including:

generating a diffuse infrared field for defining a zone;

generating a movement signal in response to the individual entering the field;

storing data indicative of a message tailored to the individual; and

being responsive to the movement signal for retrieving the data from the memory and reproducing the message at or adjacent to the field.

According to a tenth aspect of the invention there is provided a method of monitoring an individual, the method including:

providing a body;

mounting a transmitter to the body for generating a field that extends away from the body;

associating at least one receiver with the transmitter for generating a movement signal in response to the individual entering the field;

mounting a communications device to the body, the communications device having an input device for receiving audible signals and an output device for generating audible signals; and

interfacing a communications module with a communications system and the input and output devices, the communications module being responsive to the movement signal for interfacing with the communications system to allow reproduction of a live message.

According to an eleventh aspect of the invention there is provided a method of monitoring an individual, the method including:

mounting a body to a fixed support element;

movably mounting a transmitter to the body for generating two fields into which the individual is able to move, the fields remaining substantially parallel during relative movement of the transmitter and the body; and

providing at least one receiver for generating a movement signal in response to the individual entering one of the fields.

According to a twelfth aspect of the invention there is provided a method of clamping, the method including:

defining a first face with a fixed arm;

defining a second face with a movable footplate, the second face being opposed with the first face;

connecting the arms with an adjustment device, the device being rotatable for progressing the faces toward or away from each other to selectively clampingly engage an object with the faces; and

constraining relative rotation between the faces during progression of the faces toward and away from each other.

According to a thirteenth aspect of the invention there is provided a monitoring system for an individual, the system including:

a transmitter for generating, in other than the visible spectrum, a field that is unoccupied and which defines at least part of a boundary between a first region in which the individual is preferentially disposed and a second region adjacent to the first;

at least one receiver for generating a movement signal in response to the individual entering the field; and

an alarm that is responsive to the movement signal for generating an alert signal.

Preferably, the field is an infrared field. More preferably, the field is a diffuse infrared field.

In an embodiment, the field extends between a first end and a second end that is spaced apart from the first end and has a maximum nominal cross-sectional diameter of less than about 100 mm. Preferably, the maximum nominal cross-sectional diameter is less than about 80 mm. Even more preferably, the maximum nominal cross-sectional diameter is less than about 60 mm. In other embodiments smaller maximum nominal cross-sectional diameters are used. For example, where very precise definition is required for the field the maximum nominal cross-sectional diameter is less than about 20 mm.

In an embodiment, the field diverges between the first end and the second end, wherein the angle of the divergence is less than 5°. In other embodiments, however, the angle of divergence is less than 2°.

Preferably, the transmitter and receiver are contained within a housing for maintaining the field in a predetermined orientation. More preferably, the housing also contains the alarm.

Preferably also, the housing is free standing. More preferably, the housing is movable to maintain the field in an alternative orientation to the predetermined orientation.

In a preferred form, the field extends from a first end adjacent to the housing to a second end distal from the housing. Preferably, the system includes a controller for adjusting the distance between the first end and the second end. In some embodiments a continuous adjustment between a minimum and maximum distance is used, while in other embodiments a step-wise or indexed adjustment is used.

Preferably, the housing includes a battery for providing power to at least the transmitter and receiver. More preferably, the battery selectively provides power to at least the transmitter and receiver. Even more preferably, the battery selectively provides power to at least the transmitter and receiver when mains supply power is not available.

Preferably also, the alert signal is provided wirelessly.

According to a fourteenth aspect of the invention there is provided a method for monitoring an individual, the method including:

generating, in other than the visible spectrum, a field that is unoccupied and which defines at least part of a boundary between a first region in which the individual is preferentially disposed and a second region adjacent to the first;

generating a movement signal in response to the individual entering the field; and

being responsive to the movement signal for generating an alert signal.

### BRIEF DESCRIPTION OF THE DRAWINGS

Preferred embodiments of the invention will now be described with reference to the accompanying drawings in which:

FIG. 1 is a side view of a monitoring unit for an individual, the unit shown in an operative position with respect to a chair that is to be used by the individual;

FIG. 2 is a front view of the monitoring unit of FIG. 1;

FIG. 3 is a top view of the monitoring unit of FIG. 1;

FIG. 4 is a top view of two spaced apart like monitoring units shown in an operative position with respect to a bed that is to be used by the individual;

FIG. 5 is a schematic representation of the functional components contained within the housing the unit in FIG. 1;

FIG. 6 is a schematic representation of a facility in which the unit of FIG. 1 is used;

FIG. 7 an enlarged schematic representation of the communications device of FIG. 5;

FIG. 8 is a front view of a monitoring unit that is mounted to a wall;

FIG. 9 is a front view of a monitoring unit that is mounted to a bed;

FIG. 10 is an enlarged front view of a clamp in the locked configuration;

FIG. 11 is a view of the clamp of FIG. 10 in the unlocked configuration;

FIG. 12 is a side view of a monitoring unit including two infrared fields;

FIG. 13 is a top view of the monitoring unit of FIG. 12;

FIG. 14 is a top view of an alternative monitoring unit;

FIG. 15 is a front view of a monitoring unit including a movably mounted pair of sensor units;

FIG. 16 is a front view of a monitoring unit including a pair of vertically spaced apart sensor units, the uppermost of which is movably mounted;

FIG. 17 is a side view of another monitoring unit for an individual, the unit shown in an operative position with respect to a chair that is to be used by the individual; and

FIG. 18 is a schematic side view of the field provided by the monitoring unit of FIG. 1.

It will be appreciated that corresponding reference numerals are used to denote corresponding features in different embodiments, and that the drawings are not to scale.

### PREFERRED EMBODIMENTS OF THE INVENTION

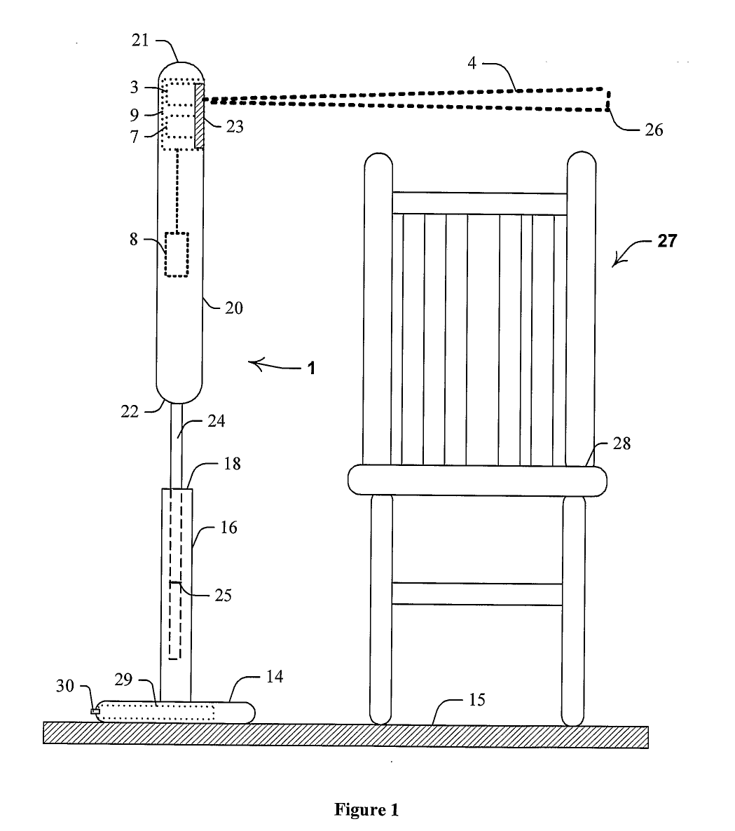

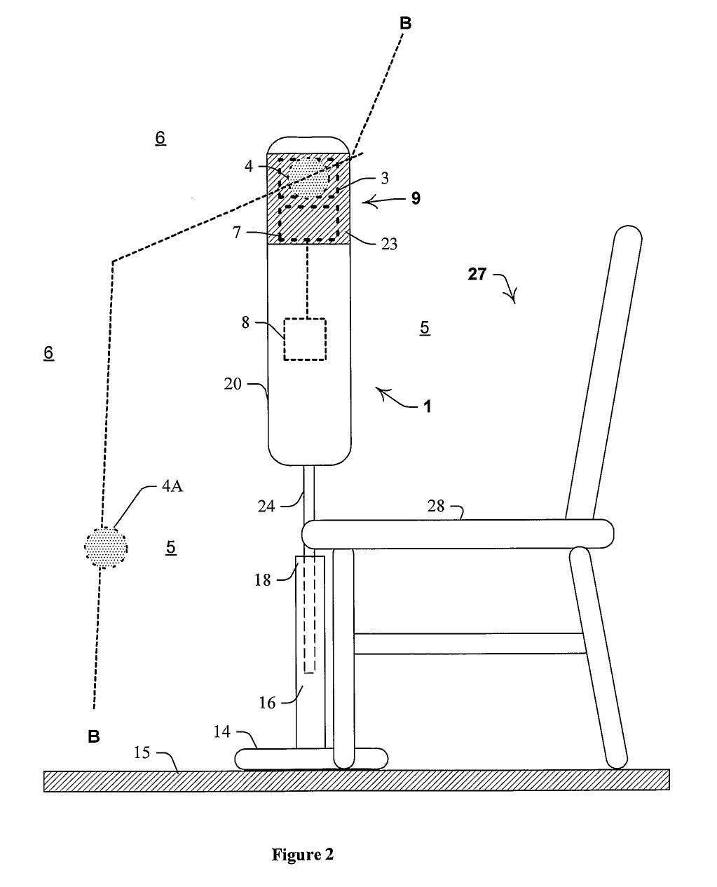

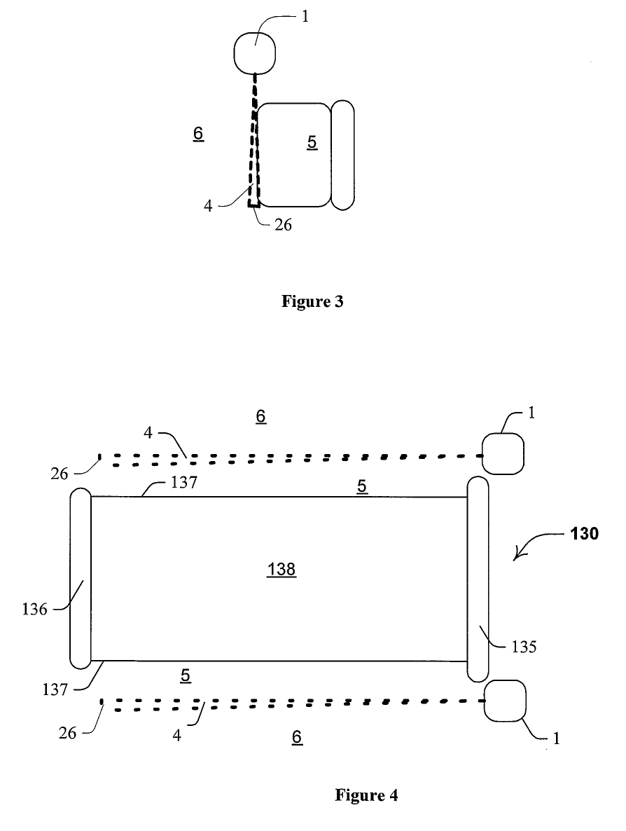

Referring to FIGS. 1 to 3, and in particular to FIG. 1, there is illustrated a self-contained portable freestanding monitoring unit 1 for an individual in the form of a human patient (not shown) in an aged-care facility 2. Unit 1 includes a transmitter 3 for generating a diffuse infrared field 4 that is indicated schematically and generally by broken lines. As best illustrated in FIG. 2, field 4 defines at least part of a boundary B-B between a first region—in the form of a zone 5 that extends generally about a chair—in which the patient is preferentially disposed and a second region—in the form of a zone 7 that is spaced apart from the chair—that is adjacent to zone 5. At least one receiver, in the form of a single infrared receiver 7, generates a movement signal in response to the patient entering field 4. Also provided is an alarm, in the form of an alarm circuit 8, which generates an alert signal in the form of an audible sequence of sounds in response to the movement signal.

Transmitter 3 and receiver 7 are included within a sensor unit 9 that has a single plastic housing. In this embodiment unit 9 is manufactured by Sick AG and designated by model number WT14. In other embodiments alternative sensor units are used, such as manufactured by Sick AG and designated by model number WT34. In other embodiments different sensor units are used.

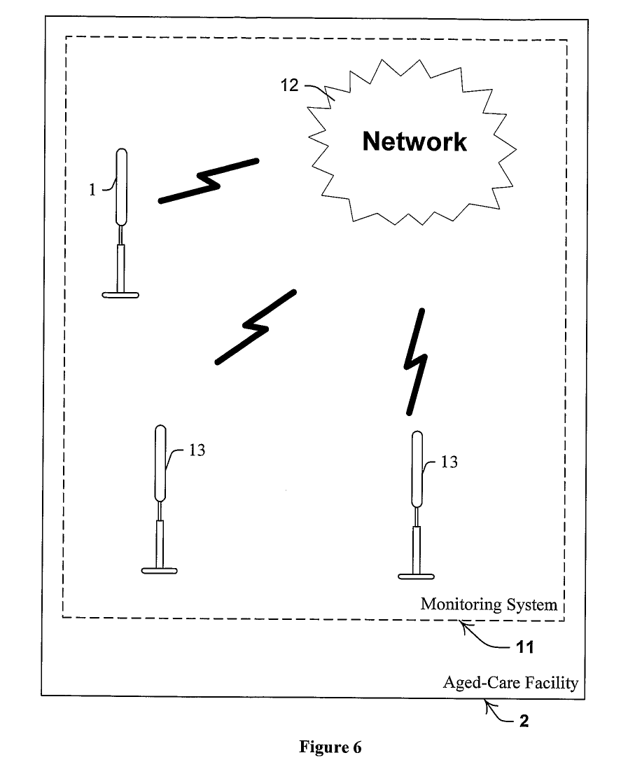

As shown in FIG. 6, unit 1 is part of a monitoring system 11 for facility 2. In this embodiment facility 2 is an aged-care facility including a group of buildings within a common perimeter for housing and facilitating the care and treatment of elderly persons. The buildings include rooms for containing individual persons, and common areas for administering treatments and for accommodating a number of the persons for social or communal events. In other embodiments, the facility is a hospital, retirement home or village, nursing home, or other health care centre. However, in further embodiments, the facility is a house, unit or other residential dwelling. For example, in one embodiment, the facility is a residential dwelling occupied by the patient, and the wireless communication is via a cellular telephone network.

System 11 includes a network 12 for communicating wirelessly with unit 1 and a plurality of like units 13. It will be appreciated that while only two units 13 are illustrated in FIG. 6, system 12 accommodates a far greater number of these units. For example, in some embodiments each patient in facility 2 has a room or dedicated area, and each room includes at least one of units 13. For larger facilities this results in many tens or hundreds of units 13 being in service at any one time.

The network 12 has one or more servers and other hardware, as well as the required software to operate the network and provide the functionality required.

Referring back to FIGS. 1 to 3, unit 1 includes a generally hollow squat moulded plastics circular base 14 for placing on a floor 15 or other substantially horizontal surface. Base 14 defines the horizontal extremes of unit 1, and is relatively dense to contribute to a low centre of gravity for unit 1 and, hence, greater positional stability for unit 1. The relatively high density of the base is achieved either through the use of ballast—as occurs in this embodiment—through the selection of the material from which the base is constructed, or both. In other embodiments base 14 has a cross-section that is other than generally circular. Moreover, in some embodiments, base 14 includes rollers, castors, or other mechanical devices to facilitate manual movement of unit 1 between alternate operative and/or storage positions within facility 2.

In other embodiments base 14 is other than generally circular.

Base 14 includes a tubular mounting formation in the form of an upstanding generally cylindrical column 16 that extends substantially normally from base 14 to an open free end 18. A moulded generally prismatic elongate plastics housing 20 contains sensor unit 9, circuit 8 and other circuitry and components that will be described in further detail below. Housing 20 extends between an arcuate top surface 21 and a correspondingly arcuate bottom surface 22, and includes adjacent surface 21a generally rectangular flat red acrylic window 23 from which field 4 emanates substantially radially and horizontally from housing 20. More particularly, sensor unit 9 is disposed within housing 20 and immediately behind window 23 for allowing transmitter 3 to generate field 4 in a region extending substantially normally outwardly from the window, and to allow receiver 7 to detect reflections from field 4 that are directed through window 23. The reflections will only be received when an object is placed within field 4 that reflects the infrared radiation emanating from window 23. That is, during normal use, field 4 is unoccupied by such an object and no alert signal is generated.

A locating formation, in the form of a generally cylindrical elongate post 24, extends downwardly from surface 22 and terminates in a free end 25 that is nested telescopically within column 16. A locking device (not shown) selectively prevents and allows relative movement between column 16 and post 24 to allow the height of window 23 to be manually adjusted relative to underlying floor 15.

Housing 20 is substantially circular in cross-section, although in other embodiments it has an alternative cross-sectional shape. Other examples include a symmetric cross-section such as rectangular, square, or other even-sided polygon. In further embodiments use is made of an asymmetric cross-section such as an elliptical cross-section. In still further embodiments the shape or area of the cross-section varies between ends 21 and 22. Preferably, however, where use is made of non-arcuate cross-sections, housing 20 includes generally smooth or chamfered edges to minimise the risk of injury should inadvertent contact be made between the housing and the patient.

In another embodiment, housing 20 includes an integrally formed handle to facilitate manual movement of unit 1 between alternate operative positions within facility 2.

Field 4 is a diffuse infrared field of substantially circular cross-section that extends from transmitter 3 and away from housing 20 to terminate at a radial periphery 26 that is about 1 metre from housing 20. In other embodiments the field terminates at an alternative distance from housing 20. In further embodiments the distance of periphery 26 from housing 20 is adjustable, and more preferably adjustable between two defined limits. For example, in one embodiment periphery 26 is infinitely adjustable to terminate between about 500 mm to 1,800 mm from housing 20. In another embodiment, periphery 26 is adjustable between the limits in a number of discrete intervals, although preferably the intervals are equal. Furthermore, some embodiments include a remote controller for allowing a nurse or other carer to remotely adjust field 4 or other operating parameters of unit 1.

It will be appreciated that field 4 adjacent to window 23 is substantially circular in cross-section and has a diameter of about 10 mm. While field 4 is substantially horizontal it also typically also diverges between window 23 and periphery 26, although the extent of that is usually dependent upon the actual transmitter used and its configuration. For example, in the FIG. 1 embodiment, divergence of the field at the periphery is about 80 mm. That is, at periphery 26 the field 4, while remaining substantially circular in cross-section, has a diameter of about 80 mm. For the purposes of the embodiment this divergence of the field between transmitter 3 and periphery 26 is not problematic. However, for more accurate or sensitive applications of the embodiments use is made of more expensive and accurate sensor units 9 that provide for less divergence in field 4.

It has been found by the inventor that for use with a bed or chair, some divergence of field 4 is acceptable and does not compromise the practical efficacy of the embodiments. That is, for the divergence mentioned above there is no significant increase in false alarms or absence of alarms when once should have been provided. It will be appreciated that too great a divergence usually leads to an increased risk of false alarms particularly. Accordingly, to contain that risk when implementing the embodiments of the invention described in this specification, the divergence of the field at the periphery is contained to less than 100 mm. That is, when operating in a mode where periphery 26 is maximally spaced from window 23, the maximum nominal cross-sectional diameter of field 4 is less than about 100 mm. More usually, however, the systems are designed for a maximum nominal cross-sectional diameter is less than about 80 mm, and more preferably, of less than about 60 mm. In other embodiments use is made of smaller maximum nominal cross-sectional diameters at the maximally spaced periphery 26. For example, where very precise definition is required for the field, or where there is only a relatively small distance between window 23 and periphery 26, the maximum nominal cross-sectional diameter is less than about 20 mm.

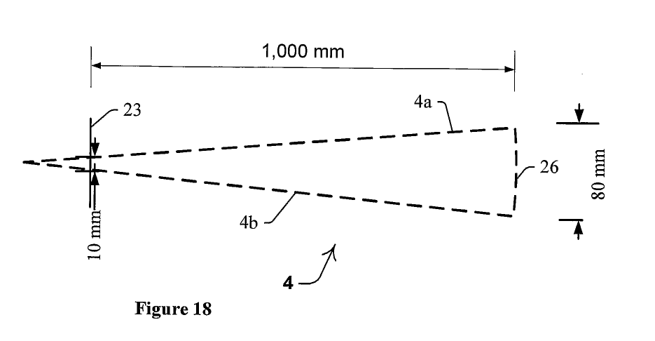

Reference is now made to FIG. 18, which is not to scale and where corresponding features are denoted by corresponding reference numerals. Particularly, field 4 is bounded by radial lines 4a and 4b that are spaced apart by about 10 mm adjacent to window 23, and which are furthest apart by about 80 mm at their respective intersections with periphery 26. As mentioned above, periphery 26 is about 1,000 mm from window 23. Accordingly, the divergence of the field is about 4°. That is, from a notional point source point behind window 23, the dispersion or divergence of field 4 is contained within a total angular spread of about 4°. In other embodiments a larger angle of divergence is tolerated, although preferably no more than 5°. In other embodiments, however, the angle of divergence is much less, and in some instances less than 2°.

It will be noted that field 4 is horizontally centred such that lines 4a and 4b equally diverge from the horizontal. In other embodiments, however, field 4 is orientated such that line 4b is substantially horizontal. In other embodiments, field 4 is orientated such that line 4a is substantially horizontal.

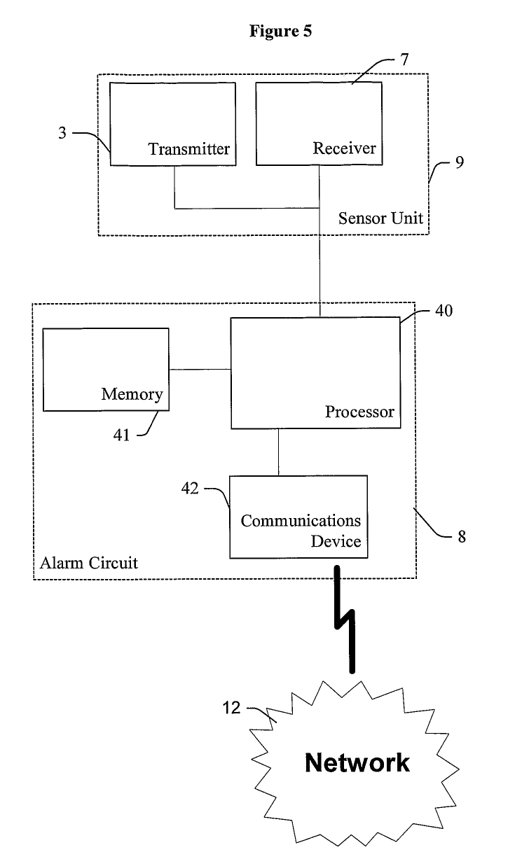

Unit 1, as shown in FIG. 1, is disposed adjacent to one side of a chair 27 such that field 4 extends across the front of the chair and periphery 26 is co-terminus with that other side. The field is approximately 950 mm above and extends substantially parallel to floor 15. Chair 27 includes a platform 28 for supporting the patient when that patient is using chair 27. It will be appreciated that chair 27 is provided to illustrate the relative positioning of unit 1 with respect to the chair, and is not typically a chair that would be used to support aged-care patients. Rather, chairs for that purpose include arms, often padded, and high backs to provide better support for the patient. More particularly, the chairs used for allowing such patients to rest or convalesce are more likely to only easily allow the patient to sit on and rise from the chair via the front of the chair. And it is across the front of the chair that field 4 extends to best ensure a movement signal is generated should the patient attempt to progress from zone 5 to zone 6. These zones are best shown in FIG. 2 where zone 5, in effect, defines the volume in which the patient has access to when seated in chair 27 and zone 6, in effect, defines the volume in the front of the chair beyond which the patient would normally move in when seated in the chair. For chair 27 the boundary between zone 5 and zone 6 is illustrated in FIG. 5 by a broken line denoted B-B. In this embodiment, field 4 defines part of that boundary, and a part that would be most likely to be passed through by the patient in attempting to rise from chair 27. Particularly for less mobile and dextrous patients the risk is low of being able to rise from the chair and move between zones without passing through field 4.

Field 4 is generated to be unoccupied such that, when it is occupied, the alert signal will be generated. That is, when initially generated and during normal conditions, field 4 will remain free of objects and items that reflect infrared energy. In the context of individual monitoring, as used in the present embodiments, this requires that the field be free of most objects likely to be used by the individual as well as the individual per se. This unoccupied field is then open to be occupied by the individual, which will result in a movement signal being generated.

In the described embodiments use is made of a field that is of other than the visible spectrum. In the specifically described embodiments, use is made of a diffuse infrared field. Being invisible to the patient imposes no restraint on the patient's movements and reduces the risk of:

Visually disturbing the patient.

Alerting the patient to the existence and extent of the field.

Housing 20 includes an externally mounted switch panel (not shown) that has at least one switch and one button. In this embodiment the switch is a power switch that toggles unit 1 between an operable and inoperable state and the button is a safety button. In the operable state field 4 is produced and, in response to a movement signal, an alert signal is generated in one or more of the available forms. In the inoperable state, circuit 8 and sensor unit 9 are disconnected from the power supply circuitry. Accordingly, field 4 is not produced and nor, therefore, is any movement signal or alert signal. The switch, however, is only responsive to toggle unit 1 between the operative and inoperative states when simultaneously the safety button is manually depressed. This reduces the risk of:
Inadvertent toggling of unit 1 between the states due to being bumped or otherwise physically disturbed.
An unauthorised person—which may include the patient—intentionally disabling unit 1 to avoid the generation of an alert signal.

The switch panel also includes a manually adjustable interface for allowing the regulation of the extent of field 4. More particularly, the interface allows the adjustment of the distance between window 23 and periphery 26. In some embodiments the interface is an infinitely adjustable manual dial, while in other embodiments the interface includes two touch pads having respective indicia representing an up-arrow and a down-arrow. Where sequential manual engagement with the pads provides for respective indexed increments and decrements to the distance between window 23 and periphery 26. The adjustment of field 4 in this manner is also only possible while simultaneously having the safety button depressed.

The ability to adjust the distance between window 23 and periphery 26 allows unit 1 to be easily adapted for monitoring the patient or sequentially monitoring different patients in different physical locations or situations. This, in combination with the portable and freestanding nature of unit 1, facilitates the wider use of unit 1 in the facility, home or other space.

In further embodiments the switch panel is located within a channel or recess within housing 20, and includes a cover that is movable between an open configuration and a closed configuration in which the various controls or interfaces are manually accessible and inaccessible. Preferably the cover is snap locked into the closed configuration.

Disposed within base 14 are a rechargeable battery pack having at least one battery and the required protection circuitry, and an associated power supply, recharging control circuitry and regulating circuitry for the battery, all of which are collectively referred to as a power supply circuit 29. The protection circuitry includes an LED that provides an external visible indication of the condition of the battery. Accordingly, if the LED indicates a low state of charge for the battery, the carer or maintenance personnel for facility 2 will be alerted to the need to recharge the battery.

The inclusion of circuit 29 contributes to the self-contained and portable characteristics of unit 1 in that it need only be connected to a mains supply when in a recharge cycle. At other times—that is, during a discharge cycle or when unit 1 is not in use—the battery pack provides the power for all the electronic components within unit 1. Additionally, circuit 29 includes a power socket 30 that extends through base 14 and which is externally available to receive an electrical power lead to connect circuit 29 to a mains power supply. This allows for ease of charging of the battery pack. Circuit 29 includes a transformer and solid-state and other electrical components for converting the mains voltage to one or more DC voltages that are used by unit 1. These electrical components are relatively heavy and are located in a compartment in base 14 to provide ballast, as referred to above. In this embodiment the compartment is sealed to reduce the risk of inadvertent or intentional tampering or damage.

Turning now to FIG. 5 there is illustrated in more detail the electronic components within housing 20. These components include unit 9—including transmitter 3 and receiver 7—which is located behind window 23, and is connected to alarm circuit 8. Circuit 8 includes a processor 40, which controls the overall operation of unit 1. Processor 40 includes a plurality of electrical components that are mounted to a common circuit board and interconnected to control and drive the overall functioning of unit 1. In this embodiment processor 40 includes a microprocessor and associated circuitry (not shown). The microprocessor communicates with the other illustrated components and/or circuits by communications ports (not shown) as will be appreciated by those skilled in the art. For the sake of clarity processor 40 is illustrated schematically and the detail of the microprocessor, the associated circuitry, and the communications ports has been omitted.

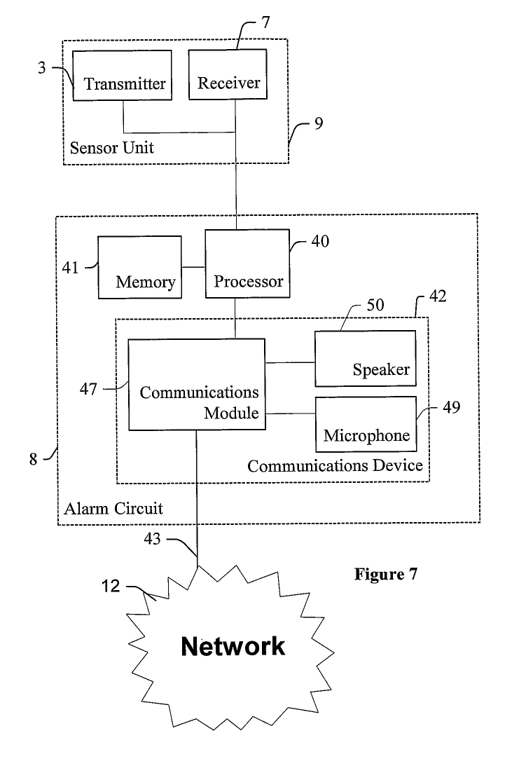

Also connected to processor 40 are:
Memory 41 having a plurality of types of data storage media for storing data and other information gathered for use by processor 40.
A communications device 42, which will be described in more detail below with reference to FIG. 7.

As mentioned above, and as illustrated in FIG. 6, multiple instances of unit 1—in the form of unit 1 and like units 13—are deployed within facility 2. In the FIG. 6 embodiment each of the units includes a respective communications device 42 having a wireless network interface (not shown) for wirelessly connecting the respective units to system 11. In the present embodiment system 11 includes a nurse-call system, and the monitoring units are configured to interact with that system—via network 12—for relaying an alert signal from alarm circuit 8 to system 11. Alternatively, each communications device 42 includes a fixed-line network interface and is connected to system 11, as shown in FIG. 7, by a network cable 43. It will be understood that in other embodiments alternative networks are used such as, for example, a cellular telephone network, a fixed-line telephone system or the Internet. In some embodiments the communications device is able to establish communication with the network via more than one communication path. In still further embodiments, device 42 is able to establish communication with an alternative network either instead of or in addition to network 12.

Device 42 includes a communications module 47 that has the required electronics to interface processor 40 with network 12, an input device—in the form of a microphone 49—and an output device—in the form of a speaker 50. In the FIG. 7 embodiment module 47 includes all the circuitry of a fixed line telephone for providing a telephony function. More particularly, module 47 is connected to a PABX (not shown) that is part of network 12 to allow connection with internal telephone numbers within facility 2 and, if the relevant permissions are provided, connection with the general telephone network and, hence, to external numbers to facility 2. In some embodiments device 42 includes an input device in the form of a telephone handset (not shown) to allow telephone calls by a person to be made from unit 1. In this embodiment, however, the telephony functionality is limited to the dialling of one or more predetermined internal numbers within facility 2 in response to the generation of the movement signal. That is, the alert signal includes the dialling of the required telephone number or numbers. If the receiving telephone is answered processor 40 generates the remainder of the alert signal by accessing a predetermined voice message from memory 41 and, via module 47, reproducing that voice message over the telephone communications session that has been established.

Microphone 49 and speaker 50 are provided not only to assist in the telephony functionality referred to above, but also to allow an intercom or “hands-free” function with network 12. That is, a nurse or other carer is able to activate the intercom function remotely (via network 12) and communicate with the patient without the patient having to hold or access a telephone handset. This functionality allows a convenient and cost effective means for communicating within facility 2. This functionality is made even more effective when used in conjunction with any video surveillance or monitoring that is provided by network 12. Additionally, microphone 49 allows a carer or another person to record a voice message that is stored in memory 41, and which is available for reproduction by speaker 50 (via module 47). In this embodiment the message is reproduced under predetermined circumstances, such as during those hours in facility 2 which are designated as rest periods. In other embodiments a message is recorded and stored on network 12, and communicated to module 47 for reproduction by speaker 50 following network 12 being informed of the alert signal by module 47.

In the above embodiments, the movement signal is that signal provided by sensor unit 9 in response to receiver 7 having detected sufficient strength of reflected radiation from field 4. This is typically a result of an attempt by the patient to progress from zone 5 to zone 6 or, in the context of the embodiment illustrated in FIG. 1, for the patient to attempt to rise from platform 28 of chair 27. Processor 40 is responsive to the movement signal for providing the alert signal, which is able to take one or more forms, one of which is described above. Others include:
An audible message relayed to the patient via speaker 50. In some embodiments the audible message is derived from data stored in memory 41, while in other embodiments the data is stored in network 12 and retrieved by processor 40 in response to the movement signal.
An electronic signal produced by circuit 8—and typically by processor 40—to which other components are responsive for providing one or more of an audible, visual, signal to one or more of a communications device near or adjacent to the patient, near or adjacent to one or both of the zones, or near or adjacent to a location likely to be frequented for monitored by a carer of the patient. For example, the audible signal generated is by a remote telephone that is contacted by circuit 8 in response to a movement signal. Another example of an alert signal is one provided on cable 43 to network 12, where that signal a nurse-call system is responsive to that signal for providing a warning—such as an audible or visual alarm—to the nurse on duty.
A visual message relayed to the patient by one or more visual displays located adjacent to zone 5. In some embodiments the visual display is connected directly to unit 1—via module 47—while in other embodiments the visual display is connected to network 12. In some embodiments the visual message is a text message and the visual display is the display of a cellular telephone. In other embodiments, the visual display is light such as an LED, and the message is a flashing of that light. In further embodiments, the visual message is delivered via a television monitor that is disposed adjacent to the boundary between zones 5 and 6.
An electronic signal sent by processor 40 to module 47 to initiate a communication session. In some embodiments the communication session is a telephone call via module 47 to one or more predetermined numbers that are dialled sequentially until the number being dialled is answered.

Accordingly, the alert signal is one or a combination of: an audible signal; an electronic signal; a visual signal; and a wireless communications signal. Moreover, the alert, signal in some embodiments is delivered directly to the patient, while in other embodiments it is not delivered directly by the patient, but to a nurse or other carer of the patient. In further embodiments, the alert signal is delivered to both the patient and a carer, but in different forms.

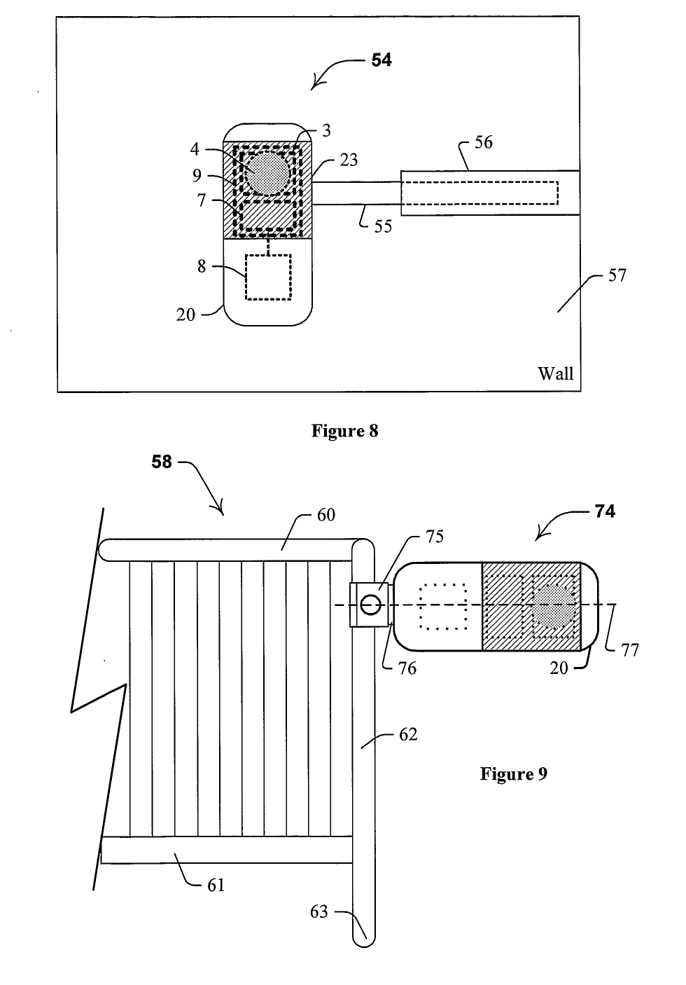

In a further embodiment shown in FIG. 8 there is illustrated a wall mounted monitoring unit 54, where corresponding features are denoted by corresponding reference numerals. Unit 54 is contained within housing 20 that is of considerably smaller vertical dimension that the housing of FIG. 1. Housing 20 is slidably attached, by a generally cylindrical arm 55, to a generally prismatic hollow plastics support element 56. Element 56 is fixedly mounted to a support surface which, in this embodiment, takes the form of a wall 57 in facility 2. In other embodiments, such as that illustrated in FIG. 9, the support surface is defined by a bed 58. In alternative embodiments the support surface is defined by, for example, a chair or other piece of furniture, a stand, a wheelchair, a trolley, a tray table, a bench or the like.

Arm 55 has a cross-section that is other than circular, and element 56 defines a channel that is shaped to complementarily receive arm 55. This prevents relative rotation of arm 55 and element 56 about a horizontal axis.

While housing 20 in FIG. 8 is elongate in a substantially vertical plane, in other embodiments the housing is elongate in an alternative plane. For example, it is also usual for housing 20 to be elongate in the horizontal plane, in that its relative orientation to that shown in FIG. 8 is 90° anticlockwise about an axis extending through the page of FIG. 8. In other embodiments alternative relative orientations of housing 20 are used, while in still further embodiments different shaped housing are used and/or different materials.

Arm 55 is movable telescopically with respect to element 56 for allowing lateral progression of unit 54 between an extended configuration (as shown) and a more nested configuration (not shown). This lateral movement of unit 54 provides for a selection of the lateral position of field 4. Element 56 extends to an opposite end that telescopically engages with a like arm 55 and unit 54 (not shown) to form a pair of units for defining two substantially parallel and spaced apart fields. These fields are available to extend along opposite sides of a bed, chair, wheelchair or another support device for a patient that is disposed adjacent to wall 57 and between units 54. It will be appreciated that the distance between the fields is adjustable—by independent lateral movement of units 54 relative to element 56—to accommodate the different support devices at different times.

Each arm 55 includes a locking device (not shown) that is movable between a locked and an unlocked configuration for respectively preventing and allowing relative movement between arm 55 and element 56.

Element 56 is mounted directly and fixedly to wall 57. In other embodiments, however, element 56 is reliably mounted to wall 57. In still further embodiments, a support bracket is fixedly attached to wall 57 and includes mounting formation for selectively and reliably retaining element 56. Preferably, a number of the support brackets are mounted within facility 2 at spaced apart locations that are frequented by beds, chairs or other support devices containing patients.

Reference is now made to FIG. 9 that illustrates part of the bed 58, and which is not shown to scale. More particularly, bed 58 includes a metal bed-head having two spaced apart substantially parallel and horizontal upper and lower lateral support members 60 and 61 respectively. A plurality of spaced-apart substantially parallel and vertical slats extends between and fixedly connects members 40 and 41. A leg 62 is fixedly connected to and extends between members 60 and 61, and terminates in a lower end 63 that is typically engaged with the floor on which bed 58 is mounted. In other embodiments, end 63 supports a wheel—for example, a castor wheel—to facilitate movement of bed 58. While only a single leg 62 is shown, it will be appreciated that the bed-head includes a second like leg that is laterally spaced apart from leg 62, and which is fixedly connected to the other end of members 60 and 61.

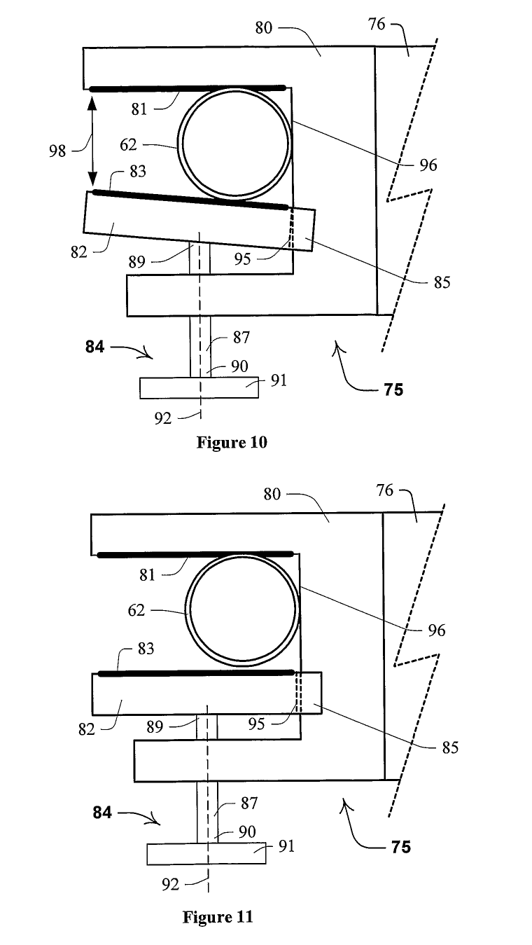

A further embodiment of a monitoring unit, in the form of a monitoring unit 74, is mounted to bed 58 and, in particular, to leg 62 intermediate members 60 and 61 and adjacent to member 60. As best shown in FIGS. 10 and 11, leg 62 is constructed from substantially circular-section steel tubing having a nominal outside diameter of 35 mm, and unit 74 includes a clamp 75 for selectively retaining the unit in a fixed relationship with respect to leg 62. In other embodiments leg 62 is made of alternative section steel tubing of the same or a different nominal diameter, or other materials.

Clamp 75 is connected to housing 20 by a generally cylindrical friction mount 76 that allows relative rotation of housing 20 and clamp 75 about an axis 77. Accordingly, while clamp 75, in use, is secured to and remains stationary with respect to leg 62, housing 20 is able to rotate about axis 77 to provide for adjustment of the orientation of the field 4 provided by unit 74.

Mount 76 provides for infinite angular adjustment between housing 20 and clamp 75, and is resiliently damped such that a separate locking device is not required. In other embodiments mount 76 is configured for indexed rotation about axis 77, while in other embodiments it is configured for rotation about axis 77 through only a given arc. In further embodiments, mount 76 is hinged to allow housing 20 to be folded normal to axis 77 and, hence, to reduce the lateral distance housing 20 extends outwardly from bed head 58. It has been found that housing 20 is typically hinged inwardly when not operable to minimise the risk of inadvertent contact with the patient, the carer, cleaners and other persons likely to be moving about the bed. That is, clamp 75 maintains unit 74 fixed to the bed, while the housing is moved between a folded and an extended configuration to respectively define an inoperative and operative state.

In further embodiments, mount 76 is fixed, and does not accommodate adjustment of housing 20—and hence field 4—without a corresponding adjustment of clamp 75.

Clamp 75 is a G-clamp and includes a rigid generally U-shaped fixed arm 80 defining a first face in the form of a generally rectangular substantially planar resiliently deformable engagement face 81. A movable footplate 82 defines a second face in the form of a generally rectangular substantially planar resiliently deformable engagement face 83 that is opposed with face 81. An adjustment device, in the form of a hand-wheel mechanism 84, connects arm 80 and footplate 82 and is manually rotatable for progressing faces 81 and 83 toward and away from each other to selectively clampingly engage and release an object—in the form of leg 62—with faces 81 and 83. At least one guide member, in the form of two like and opposed guides 55 (only one shown), extend from footplate 82 and straddle arm 80 to constrain relative rotation between faces 81 and 83.

Mechanism 84 includes a threaded rod 87 that extends between a first end 89 that is pivotally connected with footplate 82 and a second end 90 that is fixedly mounted to a hand-wheel 91. Arm 80 includes an aperture (not shown) for complementarily threadedly mounting rod 87 to arm 80. It will be appreciated that rotation of wheel 91 about an axis 92 provides for a corresponding rotation of rod 87 about that axis. Due to the threaded mounting of rod 87 to arm 80, that rotation translates into axial movement of rod 87 relative to arm 80. More particularly, it produces movement between faces 81 and 83. In this embodiment, clockwise rotation of wheel 91 advances faces 81 and 83 toward each other, while anti-clockwise rotation retreats faces 81 and 83 away from each other.

The pivotal connection of end 89 to footplate 82 allows for constrained rotation between end 89 and footplate 82 about the axes normal to axis 92. These axes, with the exception of axis 92, will be collectively referred to as “the normal axes”. The constraint of the rotation about the normal axes is limited, in this embodiment, by guides 85 and that edge 95 of footplate 82 that is adjacent to arm 80.

Arm 80 includes an abutment surface 96 that, in use, engages with leg 62. As in, in use, clamp 75 is configured with faces 81 and 83 being spaced apart by more than the nominal diameter of leg 62—as illustrated in FIG. 11—such that leg 62 is able to be received between those faces and subsequently engaged with surface 96. Thereafter, faces 81 and 83 are progressed toward each other to engage with opposite sides of leg 62.

Axis 92 is substantially parallel to surface 96, and spaced laterally from that surface by about 30 mm. Accordingly, face 83 engages leg 62 between axis 92 and surface 96 to provide, in effect, an over-centred configuration. The result of which is that footplate 82 is rotated about one of the normal axes and remains canted—as shown in FIG. 10—for so long as clamp 75 is maintained in the clamped configuration. This canting of footplate 82 results not only in faces 81 and 83 clampingly engaging leg 62, but captively retaining it by clamp 75. More particularly, the minimum distance between faces 81 and 83—illustrated as distance 98—is considerably less than the nominal diameter of leg 62. Moreover, the minimum distance between faces 81 and 83 lies within the path that would be taken by the clamped object—that is, leg 62—to allow removal of clamp 75 from that object.

Faces 81 and 83 define friction surfaces, and are provided by respective thin rectangular pads of relatively high-density resiliently deformable material. In this embodiment, the pads are of 1.5 mm thick high-density polyurethane material sold by 3M and designated as SJ5816 “BUMP-ON”. This material has a coefficient of friction of about 0.84. In other embodiments alternative materials are used, but the preference remains for a coefficient of friction of at least 0.8, and more preferably at least 0.84. It has been found that when using pads of this material is it preferred to have the thickness of the pad at less than 2 mm. Moreover, it is preferred that arm 80 and footplate 82 are rigid plastics, and include respective generally rectangular detents into which the pads are set. More preferably, the periphery of the pads and the corresponding detents are substantially continuously abutted to better resist relative rotation between the pads and the footplate or arm, respectively. In some embodiments, the pads are adhered to the adjacent footplate and arm, while in other embodiments they are heat welded, integrally formed or otherwise mounted.

The use of resiliently deformable material to define faces 81 and 83 allows for an increased clamping and capturing effect as faces 81 and 83 are engaged with leg 62. Particularly, faces 81 and 83, upon engagement with leg 62, resiliently deform to closely conform to the respective adjacent surfaces of leg 62. This further “locks” or “keys” the faces to the leg and better resists attempts to move clamp 75 relative to leg 62.

Clamp 75 uses a combination of rigid components—that is, arm 80, footplate 82 and rod 87—and resiliently deformable components—that is, the pads that define surfaces 81 and 83—to provide a secure releaseable mount for the monitoring unit 74.

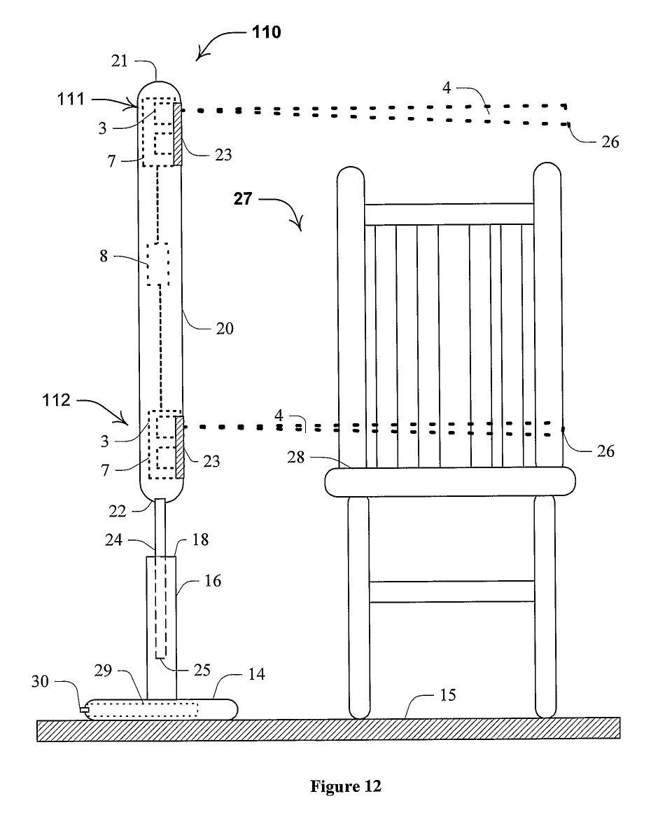

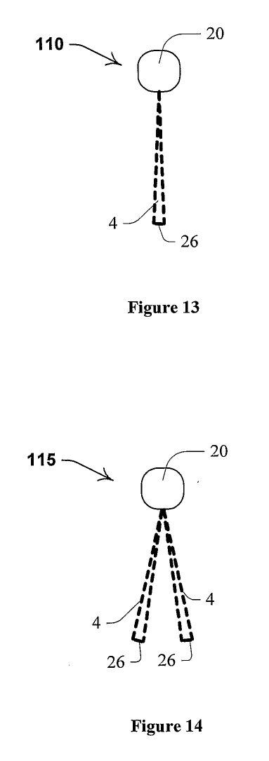

In other embodiments the monitoring unit contains more than one sensor unit 9. For example, there is illustrated in FIG. 12 a monitoring unit 110 that includes two spaced apart sensor units 111 and 112, where corresponding features are denoted by corresponding reference numerals. Unit 111 is located similarly to unit 9 of the FIG. 1 embodiment, in that it is adjacent to end 21 of housing 20 such that it is disposed at approximately head-height for the patient (not shown) when sitting in chair 27. The “head-height” will varying considerably due to different physical attributes of one or more of: the patient; the chair; and the surface upon which base 14 is disposed. That said, a typical range for the height of unit 111, and in particular of field 4, is about 800 mm to 1,200 mm above floor 15.

Unit 112 is spaced vertically below unit 111 and located within housing 20 adjacent to end 22 such that it is located at about knee-height for the patient when in chair 27. While the “knee-height” will also varying considerably due to different physical attributes of the patient, the chair and the surface upon which base 14 is disposed, a typical range is about 400 mm to 500 mm above floor 15. In this embodiment unit 111 and 112 remain in a fixed spaced apart relationship, with unit 111 being disposed about 950 mm above floor 15, and unit 112 being disposed about 450 mm above floor 15.

Unit 110 is adjustable in height to allow selective placement of units 111 and 112. The adjustment is affected by varying telescopically the extent to which post 24 is nested within column 16. It will be appreciated that during any adjustment, units 111 and 112 will remain fixedly spaced apart by the same vertical distance.

In other embodiments unit 110 is fixed. That is, the height of the sensors is fixed relative to floor 15.

Units 111 and 112 are only operable mutually exclusively. This is due to the placement of unit 110 relative to chair 27 is different depending upon which of units 111 and 112 is operable. For example, if unit 111 is operable, unit 110 is monitoring for an attempt by the patient to rise from chair 27. This is detecting how a more mobile patient would attempt to move from zone 5 to zone 6. If unit 112 is operable, however, unit 110 is monitoring for movement of the patient from zone 5 to zone 6 at a much lower point along boundary B-B. By way of contrast, there is illustrated in FIG. 1 a field “4A” that is representative of where the field provided by unit 112 is typically disposed. When unit 112 is operable, unit 110 is monitoring for what would typically be a fall of the patient from the chair. In such circumstances it is usual initially for the patient to slump on the chair and slide downwardly such that their torso is adjacent to the platform 28 of chair 27. In this position the patient's legs normally extend out from the front of the chair and into field 4. If the patient continues to slide they will fall to the floor 15.

While unit 110 includes two sensor units 111 and 112, both the sensor units interface with a single alarm circuit 8.

The respective fields 4 produced by units 111 and 112 are substantively aligned with each other, in that they are substantively parallel. In this embodiment, fields 4 are also co-extensive, in that the respective peripheries 26 are substantially equidistant from respective window 23. In other embodiments units 111 and 112 produce respective fields that are not aligned and both units are usable simultaneously. An example of such an alternative monitoring unit is monitoring unit 115 that is illustrated in FIG. 14, where corresponding features are denoted by corresponding reference numerals. Particularly, the fields 4, while both extending substantially horizontally from housing 20, diverge radially from each other. Housing 20 is placed near chair 27 and rotated such that the uppermost field 4 is disposed substantially as illustrated in FIG. 1 at about head-level for the patient, while the lowermost field 4 extends across the front of chair 27 substantially at the knee-level for the patient.

In other embodiments the angle of divergence between fields 4 is different to that illustrated in FIG. 14. In further embodiments, the divergence between fields 4 is adjustable. Moreover, in alternative embodiments one or both of fields 4 are not substantially horizontal.

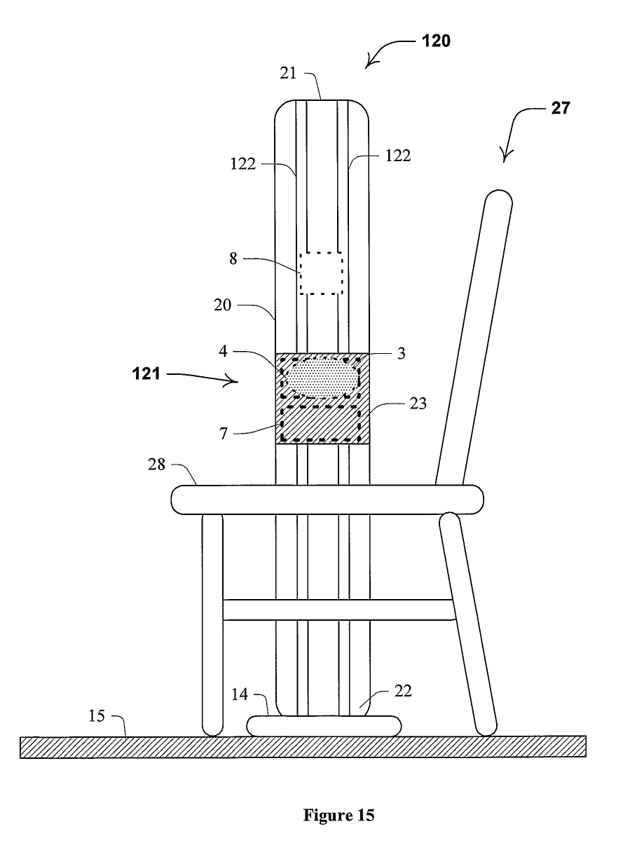

Another monitoring unit, unit 120, is illustrated in FIG. 15 where corresponding features are denoted by corresponding reference numerals. This unit 120 includes a sensor unit 121 that is mounted slideably to housing 20 for movement between ends 21 and 22. In this embodiment the mounting is a friction mount that resists movement sufficiently to maintain unit 121 at a given location between ends 21 and 22 when no additional external forces are applied, but which is relatively easily overcome by a manually applied force. In other embodiments use is made of a locking device (not shown) for releasably securing unit 121 selectively at a predetermined location between ends 21 and 22.

Unit 121 is mounted to a carriage that progresses along two parallel and spaced apart rails 122 to affect the movement between ends 21 and 22. In other embodiments an indexed mounting system is used for allowing selective placement of unit 121 at one or a plurality of spaced apart locations.

The above monitoring units have been specifically illustrated for use with a chair. However, the units are equally applicable for use with a bed, wheelchair, doorway, or other furniture or access point that is able to conveniently delineate two adjacent zones, between which it is desired to monitor patient movement. The application of monitoring unit 1 to a bed 130 is illustrated in FIG. 4 where use is made of two like monitors. Bed 130 includes a bed head 135, a foot 136, two longitudinally extending laterally spaced apart edges 137 that extend between head 135 and foot 136, and a generally rectangular surface 138 that is bounded by head 135, foot 136 and edges 137 for supporting the patient during normal use. It will be appreciated that in other embodiments it is necessary to monitor only one side of bed 130 and, as such, only a single monitoring unit 1 is used. This occurs, for example, when one edge 137 of bed 130 is disposed adjacent to a wall, and as such it is only necessary to have a single monitoring unit that provides a field adjacent to the other edge 137 of bed 130. Another example is where bed 130 includes a raised gate or other barrier adjacent to one of edges 137 for preventing the patient from entering or exiting bed over that edge.

Both monitoring units 1 are disposed adjacent to bed head 135 and provide respective fields 4 that are substantially parallel with each other and edges 137. The fields are located about 150 mm above the height of surface 138, and about 150 mm laterally spaced from respective adjacent edges 137. Moreover, peripheries 26 are substantially co-terminus, and disposed adjacent to foot 136. Zone 5 is defined in part by fields 4, and in part by bed head 135 and foot 136. In practice, particularly for elderly or less mobile patients, the only egress from zone 5 to zone 6 is achieved by passing over one of edges 137. If that occurs the patient will enter or pass through the respective field 4, and an alert signal will be generated.

It will be appreciated by those skilled in the art, on the basis of the teaching herein, that units 1 are able to be placed adjacent to foot 136 rather than, as shown, adjacent to head 135. It will also be similarly appreciated that both units 1 need not be adjacent the same end of bed 130, in that one is able to be adjacent head 135 and the other adjacent foot 136.

In the FIG. 4 embodiment the fields collectively define a portion only of the boundary between zones 4 and 5. Moreover, the fields extend along respective portions of the boundary that each has no physical barrier to prevent progress of the patient from one zone to another. That is, the fields extend across respective access points between the zones. In the FIG. 4 embodiment there are two access points, the first being defined collectively by one of edges 137, head 135 and foot 136, and the other being defined collectively by the other of edges 137, head 135 and foot 136.

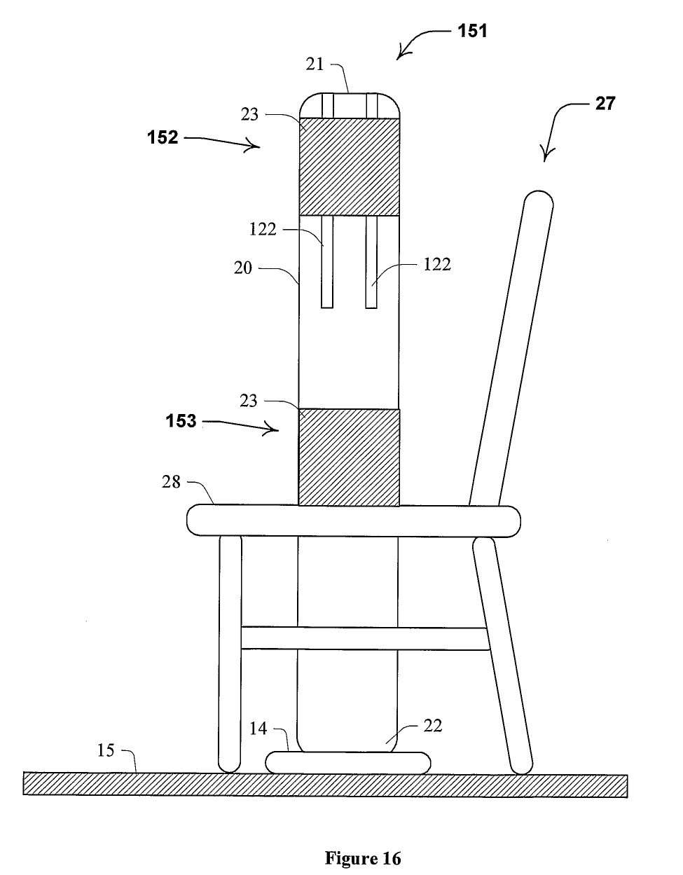

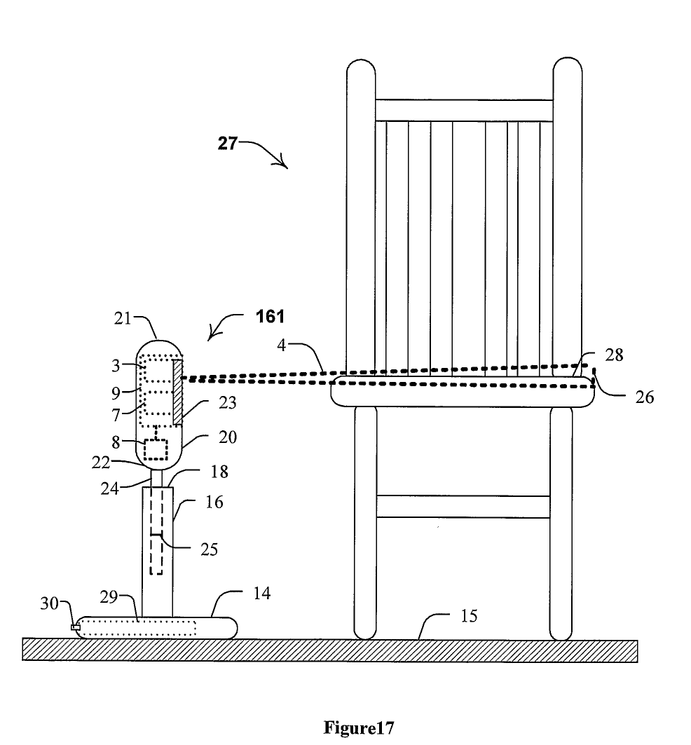

Another monitoring unit 151 is illustrated in FIG. 16, where corresponding features are denoted by corresponding reference numerals. Unit 151 includes two spaced apart sensor units 152 and 153 that are mutually exclusively operable. While only the respective windows 23 are illustrated, it will be appreciated that within housing 20 there is located the other components required to allow operation of unit 151.

Unit 153 is fixedly mounted to housing 20 at about 450 mm about floor 15. Unit 152, however, is mounted to housing 20 for relative vertical movement between an uppermost position adjacent to surface 21, and a lowermost position closer to unit 153. As illustrated, unit 152 is disposed and locked intermediate the uppermost and lowermost positions.

In other embodiments, both units 152 and 153 are movable independently.

As described above, some embodiments of the monitoring units allow adjustment of one or more of the fields without having to move housing 20. In the above embodiments this is achieved by having the sensor units movably mounted to housing 20. In other embodiments only part of the sensor units are movably mounted to housing 20. The adjustment most usually sought, and provided, is vertical adjustment. However, in some embodiments angular adjustment is also provided.

Another embodiment of the invention, in the form of a monitoring unit 161, is illustrated in FIG. 17 where corresponding features are denoted by corresponding reference numerals. Unit 161 provides a field 4 that extends substantially horizontally in front of chair 27 at about 450 mm above floor 15. Movement of the patient that results in the field being entered by the patient results in an alert signal being generated. The typical scenario for the patient attempting to rise from chair 27 is for the patient's body to be moved forward on platform 28 and for the patient's knees or legs to enter the field. Another scenario for aged patients particularly is for the patient's body to slump in the chair—in that the patient's back slides down the back of the chair—and sometimes to entrap the patient in an awkward position from which he or she is unable to move. In this scenario, the patient's knees move forward and into field 4 and result in an alert signal being generated.

Embodiments of the monitoring unit include a number of controls, some of which are described above, for allowing selective adjustment of one or more operating parameters of the respective unit. Examples of these controls include:
A safety switch that, unless depressed, prevents that other controls being operable.
An ON/OFF switch for allowing selective powering of the monitoring unit. That is, the switch is moved to the ON position to when it is to be operable, and to the OFF position when it is to be inoperable, inactive, or in standby mode.
A volume control for the communications device for allowing selective adjustment of the volume of any message reproduced via the speaker. This allows the volume to be higher for those patients who are hearing challenged, and for the volume to be lessened at night, for example, when ambient noise is less.
A record control that is manually depressed by a carer or other person to actuate the microphone and to record and store in memory the sound sensed by the microphone. That is, to allow a message to be recorded for subsequent playback by the communications device.
A play control for allowing the carer or other person to access the relevant data from memory and have the message reproduced by the speaker.
A field adjustment control for varying one or more properties of the field. For example, adjusting the strength of the field, or the distance of periphery 26 from the housing 20, or other properties such as the sensitivity of sensor unit 9.
A mute control to switch unit between two states where one or more recorded messages respectively are and are not able to be reproduced via the speaker.

In the described embodiments, the monitoring unit includes an interlocking function switch to better secure the manual operation of the above controls. In some embodiments the function switch has to be continually depressed while the other controls are adjusted for that adjustment to be effective. In other embodiments, the function switch is moved between an operable setting and an adjustment setting. In that when the adjustment setting and the operable setting a manual change to a selected control does and does not respectively result in a corresponding change to the characteristic being controlled. This reduces the risk of the patient or other individual inadvertently adjusting the controls. In other embodiments the interlocking function switch acts only for allowing and preventing adjustment of less than all the available controls. In particular embodiments, the interlocking function switch acts only for preventing and allowing adjustment of the main power ON/OFF switch for the monitoring unit.

In some embodiments the memory is removable and non-volatile for storing various data, and in particular, for storing data indicative of a message tailored to the patient. When the movement signal is communicated to processor 40, it retrieves data indicative of a message from memory 41 and reproduces the message via communications device 42. In one instance of FIG. 7, for example, the message is an audio message and is relayed to the patient via speaker 50. The message is pre-recorded in a relative's tone of voice and is in the form of a request. In some cases, it has been found that the patient feels more reassured and will therefore be more likely to comply with the request if they recognise the relative's voice.

The microphone 49 and speaker 50 within communications device 42 in the FIG. 7 embodiments are used to provide intercom functionality, telephony functionality, and recording and playback functionality. While this allows the recording of a message directly at unit 1, in other instances the message is recorded elsewhere—for example, within network 12—and communicated to device 42 for storage in memory 41.

In a further embodiment, device 42 interfaces with network 12 to allow reproduction of a live message. In one aspect, network 12 is the nurse-call system of facility 2, and a carer having access to a control console is instantaneously alerted to the activation of unit 1. The control console includes an interface to network 12, and has a microphone that the carer is able to use to communicate a live message to the patient via network 12 and device 42. In another embodiment, network 12 is a mobile or fixed line telephone network.

In some embodiments device 42 is configured to receive commands through network 12 to allow remote configuration and/or operation of unit 1. One example of this remote operation includes a carer at the control console deactivating unit 1 during periods it is known the patient is undertaking other activities. Another example includes the carer remotely cancelling an alarm signal generated by unit 1 once it has been established that the situation has been addressed or remedied.

Other than chairs, the above embodiments have many other applications. For example, they are also applicable to monitor animals or pets, or to be placed adjacent to a doorway or other opening.

The embodiments have been described above with reference to detecting the progress of the patient from a bed, chair or other furniture, and is expressed in terms of detecting an attempt by the patient to move from zone 5 to zone 6. If such an attempt is detected, an alert signal is generated and relayed directly to one or more of the patient, a carer or other staff member. This signal is provided to discourage patients—particularly those who are not in full control of their faculties or who are less mobile—from unassisted movement from the chair. For such movement puts the patient at risk of a fall. In other embodiments the monitoring units detect an attempt by the patient to climb into the bed, chair or other furniture while, in further embodiments, the monitoring units detect attempts at movement to and from the bed or other furniture. It has been found that while there is a risk of a fall when the patient attempts to move from the bed, it is also recognised, at least for some patients, that the risk is as least as great when attempting to leave the bed.

It is preferred that a log is kept of the alert signals generated. In some embodiments the log includes a date stamp and a record identifying the monitoring unit giving rise to the alert signal. In other embodiments, the log also includes data indicative of the carer who was assigned to respond to the alert signal and a time stamp for when the monitoring unit was manipulated to indicate the alarm condition was responded to. For example, in the FIG. 5 embodiment, a log of the alert signals are maintained in memory 41 and periodically uploaded to network 12. However, in other embodiments, network 12 includes a database that is responsive to the alert signal for creating the log, and adding to that log as subsequent updates are obtained. This information is then available to more accurately assess the future needs of the patient, to plan staffing levels within the facility, to levy charges for the care of patients, and to assess at least some aspects of the performance of personnel within the facility.

For more mobile patients use is made of a monitoring unit with additional functionality. For example, one such embodiment includes a timer circuit that is responsive to the movement signal for generating the alert signal after a predetermined time. Moreover, if a further movement signal is received within that predetermined time, the alert signal is not generated. In the above embodiments, the timer circuit is included within circuit 8, and embodied within the functionality of processor 40. The timer circuit allows a more mobile patient to leave the bed, for a short period prior to an alert signal being produced. And so long at the patient returns to the bed within the predetermined time, the alert signal will not be produced. While the duration of the predetermined time is determined in accordance with the state and ability of the patient, it is not unusual to have that time set at about four minutes, and even up to ten minutes. This is often enough time for the patient to use a toilet, obtain a blanket, obtain a drink, or other minor task that is likely to occur between intervals of sleep.

In some embodiments of the monitoring system, use is a made of a hand held or other portable alarm device that is carried by a carer within a given facility. For example, in one such facility the alarm device includes a pager (not shown) that is interfaced with network 12 and which is responsive to an alert signal for a given patient for receiving and displaying data indicative of the patient. The carer is then able to expeditious move to provide assistance to the relevant patient. In some embodiments the pager includes a vibrator that actuates simultaneously with the data being displayed.

Other embodiments of the monitoring units include magnetic induction loops for facilitating voice messages being cognised by those patients with hearing aides.

Further embodiments include a remote control unit for use by the carer. This unit allows remote, but line of sight, control of one or more of the functionalities of the monitoring unit. It has been found for facility 2, where many like monitoring units are deployed, often within a common area, it is beneficial for a carer to be able to cancel an alarm signal. This is particularly relevant for those monitoring units where the message is a relatively high volume audible message which, if left to fully play, will considerable risk disturbing other patients.

In other embodiments alternative wireless remote control units are issued to the carers to interact with the monitoring units. Preferably, however, the remote control units are only able to interact with a monitoring unit that is within line of sight of the carer, or which is in close proximity to the carer to reduce the chances of an alarm being inadvertently cancelled without the carer having attended to the patient.

While the above embodiments have been primarily described above for use in a facility such as facility 2, other applications include home nursing for elderly or less mobile patients. A particularly advantageous embodiment of the monitoring unit for home nursing incorporates within housing 20 a cellular telephone module. This module is responsive to a movement signal for connecting with one or more predetermined telephone numbers. In a typical scenario the patient is an elderly person living close to, but semi-independently from, a carer who may be a family member. In the event of a fall, the carer will be contacted via the cellular communications system to which the cellular module operates.

The preferred embodiments of the invention described above make use of a well-defined field that is unoccupied during normal use. This allows the field to accurately define part or all of the boundary between the two zones, and to be mounted relative to the patient so as to better contain the risk of false alarms while also providing an early warning to a carer about movements of the patient that are indicative of that the patient being soon at risk of a fall. It also allows the field to be positioned so that the patient has relative freedom of movement within the first zone without overt fear of generating a false alarm.

Moreover, in the described embodiments, the field is generated from electromagnetic radiation that falls outside the visible spectrum. In the case of the diffuse infrared beam, this obviates the need for any reflectors to be positioned to define one end of the field. This reduction in components not only simplifies manufacture and installation of the monitoring system of the embodiments, but also reduces effort in ongoing use and tuning of the system.

The above embodiments offer one or more of the following advantages:
Freestanding.
Self-contained.
Selectively battery powered.
Portable due to being relatively low weight and either self-contained or releasably mounted.
A field that is tuneable in either or both of orientation or distance from the transmitter to accommodate the needs of the specific patient being monitored.
A field that is able to be accurately defined.
A field that is, in normal use, unoccupied.
A field that is generated in other than the visible spectrum.
Easily moveable between different locations for allowing a fewer number of monitoring units to seamlessly monitor an individual or multiple individuals at different times in the day.
Does not present a physical barrier to the patient.
Ability to provide a wireless alert signal.
Ability to communicate wirelessly with a nurse call system or other network.
Early warning of patient being exposed to a risk of a fall or other injury.
Long operational life.
Providing personalised voice messages to the patient as part of the alarm signal.

This specification incorporates by way of cross-reference all the disclosure from both Australian patent application 2006252036 filed 11 Dec. 2006 and Australian patent application 2007904821 filed 5 Sep. 2007. For, as will be understood by the skilled addressee, the features disclosed in these earlier patent applications are, with the benefit of the teaching herein, also suitable for use in one or more of the embodiments disclosed within the present patent specification. For example, in some embodiments of the present invention a monitoring unit includes more than one transmitter and receiver pair as disclosed in Australian patent application 2007904821. By way of further example, additional processing of the logs and other data gathered from the operation of the monitoring system occurs as also disclosed in the Australian patent application 2007904821.

Although the invention has been described with reference to specific examples, it will be appreciated by those skilled in the art that the invention may be embodied in many other forms. For example, while for the sake of conciseness the above embodiments disclose specific combinations of features, the skilled addressee will understand, particularly given the benefit of the disclosure herein, that any feature of a given embodiment is able to be combined with another or other features from another of the embodiments to define other combinations.

1. A monitoring system for an individual, the system including:
a transmitter for generating, in other than the visible spectrum, a field that is unoccupied and which defines at least part of a boundary between a first region in which the individual is preferentially disposed and a second region adjacent to the first;
at least one receiver for generating a movement signal in response to the individual entering the field; and
an alarm that is responsive to the movement signal for generating an alert signal.

2. A system according to claim 1 wherein the field is an infrared field.

3. A system according to claim 1 wherein the field is a diffuse infrared field.

4. A system according to claim 1 wherein the field extends between a first end and a second end that is spaced apart from the first end and has a maximum nominal cross-sectional diameter of less than about at least one of: 100 mm; 80 mm; 60 mm; and 20 mm.

5. A system according to claim 1 wherein the field diverges between the first end and the second end, wherein the angle of the divergence is less than 5°.

6. A system according to claim 1 including:
memory for storing data indicative of a message tailored to the individual; and
a communications device that is responsive to one or more of the movement signal and the alert signal for retrieving the data from the memory and reproducing the message at or adjacent to the field.

7. A monitoring system according to claim 6 wherein the message is reproduced audibly.

8. A monitoring system according to claim 6 wherein the message is reproduced visually.

9. A monitoring unit for a monitoring system for an individual, the monitoring system having memory for storing data indicative of a message tailored to the individual and a communications device that is responsive to a movement signal for retrieving the data from the memory and reproducing the message, the monitoring unit including:
a transmitter for generating an infrared field; and
at least one receiver for generating the movement signal in response to the individual entering the field.

10. A monitoring unit according to claim 9 wherein the transmitter and the at least one receiver are co-located.

11. A monitoring unit according to claim 10 wherein the transmitter and the at least one receiver are co-located within a common housing.

12. A monitoring unit for a monitoring system for an individual, the monitoring unit including:
a body for mounting to a fixed support element;
a transmitter movably mounted to the body for generating two fields into which the individual is able to move, the fields remaining substantially parallel during relative movement of the transmitter and the body; and
at least one receiver for generating a movement signal in response to the individual entering one of the fields.

13. A monitoring unit according to claim 12 wherein the transmitter is an infrared transmitter and the field is an infrared field.

14. A monitoring unit according to claim 12 wherein the transmitter generates a plurality of fields having respective orientations.

15. A monitoring unit according to claim 14 wherein the orientations are relatively adjustable.

16. A monitoring unit according to claim 15 wherein the fields are substantially parallel and the relative adjustment is of the spacing between the fields.

22.-27. (canceled)
